(19) United States
(12) Patent Application Publication
(10) Pub. No.: US 2011/0291366 A1
(43) Pub. Date: Dec. 1, 2011

(54) Method & Apparatus for Active Sealing and Preform Deep Drawing Composite Materials

(76) Inventor: Jamin Micarelli, Kirkland, WA (US)

(21) Appl. No.: 13/113,070

(22) Filed: May 22, 2011

Related U.S. Application Data
(60) Provisional application No. 61/348,215, filed on May 25, 2010.
(60) Provisional application No. 61/348,219, filed on May 25, 2010.

(51) Int. Cl. F16J 15/06

(52) U.S. Cl. 277/628

(57) ABSTRACT

A wedging gasket with an outer relatively rigid member with a surface that is in mating press fit relationship to a vessel or lid to be sealed. The gasket also has a slightly angled inner slightly resilient member appropriately shaped to mate with a respective other part of the vessel or lid to be sealed, generally in something less than an interference fit.

This application claims priority to the following two US Provisional Applications, all filed May 25, 2010: 61/348,215 and 61/348,219.

### TECHNICAL FIELD

The invention relates to the high pressure composite materials presses; more particularly, it relates to methods and apparatus for active sealing in such presses and preform deep drawing of composite materials.

### BACKGROUND OF THE INVENTION

### Active Sealing

Manufacturing with advanced high density composites requires pressure vessels capable of delivering very high pressures. In addition, composite lay-ups in the pre-press stage entrain a significant amount of trapped air, which, if it is not released prior to applying the high pressure, results in flawed composites, often brittle or likely to fail well below expected performance parameters.

In a conventional low pressure autoclave, heat and pressure are applied to a composite part that is wrapped in a vacuum bag, which is in turn connected to a vacuum line. A vacuum is drawn down on the part to evacuate all trapped air from the part, and the vacuum is maintained during application of the pressure, so that whatever air the initial vacuum could not entice out, is pressed out under the pressure of forming the part. This conventional method works, in part, because of the relatively low order of pressure (typically <400 psi, commonly about 200 psi) being applied internally, not only to the bagged part, but also to the vacuum lines themselves.

Such a vacuum system will not work in a chamber that delivers much greater pressure, and certainly not in a chamber where pressures may reach 10,000 psi; the vacuum lines themselves would be crushed.

Of course another well-known alternative for a press to release trapped air is a so-called flat press, with no restrictions on air escaping from the sides of the part.

What is needed is an apparatus and process that can be used in a very high pressure composite press that will allow all entrained air to escape or be pressed out of the part before it is subjected to the full working pressure of the press.

### Very High Pressure Composite Presses

While the autoclave and/or vacuum bag press can reduce or eliminate the uneven pressure created by the match die press, they do not reach the necessary pressure required to optimize the applied ballistic sheets. Autoclave and vacuum bag products will be heavier than necessary because they can not be formed under appropriate high pressures.

An autoclave in general applies both heat and pressure to the workpiece placed inside of it. Typically, there are two classes of autoclave. Those pressurized with steam process workpieces which can withstand exposure to water, while the other class circulates heated gas to provide greater flexibility and control of the heating atmosphere.

Processing by autoclave is far more costly than oven heating and is therefore generally used only when isostatic pressure must be applied to a workpiece of comparatively complex shape. For smaller flat parts, heated presses offer much shorter cycle times. In other applications, the pressure is not required by the process but is integral with the use of steam, since steam temperature is directly related to steam pressure. Rubber vulcanizing exemplifies this category of autoclaving.

For exceptional requirements, such as the curing of ablative composite rocket engine nozzles and missile nosecones, a hydroclave can be used, but this entails extremely high equipment costs and elevated risks in operation. The hydroclave is pressurized with water (rather than steam); the pressure keeps the water in liquid phase despite the high temperature.

Hydroclaves in general use water as the pressurizing medium. Since the boiling point of water rises with pressure, the hydroclave can attain high temperatures without generating steam. While simple in principle, this brings complications. Substantial pumping capacity is needed, since even the slight compressibility of water means that the pressurization stores non-trivial energy. Seals that work reliably against air or another gas fail to work well with extremely hot water. Leaks behave differently in hydroclaves, as the leaking water flashes into steam, and this continues for as long as water remains in the vessel. For these and other reasons, very few manufacturers will consider making hydroclaves, and the prices of such machines reflect this.

What is needed is a new kind of press or pressure chamber where both heat and isostatic pressure can be applied to layered composites over comparatively complex shapes.

### Preform Deep Draw

Current deep draw methods for ballistic material rely on using multiple pieces of material specially shaped so that the final drawn product will have a uniform thickness. These methods are believed to create weaknesses in the final drawn end product because using various shapes for the material to be drawn is believed to be inherently weaker than using full sheets. Other methods of deep drawing composite material are believed to also stretch or harm the material such that it loses at least some of its ballistic properties.

### DISCLOSURE OF THE INVENTION

### Active Sealing

We have developed and elsewhere disclosed a very high pressure press meeting the requirements set forth above and we call such a press or pressure chamber a Boroclave. The Boroclave does not use water as a pressuring or pressure transfer medium. A Boroclave can be either oil or silicon filled, or a combination of both, with suitable separation materials.

In a disclosed Boroclave press it is advantageous to employ compressible gaskets to seal in silicone under high pressure. These gaskets may be conventional, or they are desirably a novel silicone filled, wedging arrangement as disclosed herein. In general, disclosed wedging gaskets have one (typically an outer, but could optionally be inner) relatively rigid member with a surface that is in mating press fit relationship to the vessel or lid to be sealed, and another, slightly angled, inner (or outer) slightly resilient member appropriately shaped to mate with the respective other part of the vessel or lid to be sealed, generally in something less than an interference fit. The requisite slight resilience of the angled member is achieved with selection and dimensioning of the material of the angled member, as will be appreciated by those skilled in the art, so that the angled member can be deformed and then spring back to its original dimension and configuration.

A space or void between the gasket outer member and the angled inner member is advantageously filled with silicone or other substantially incompressible but elastomeric medium. In operation then, as the lid is closed or the pressure chamber is otherwise closed, the angled inner member of the gasket is aligned and preliminarily mated with its respective sealing surface. This preliminary mating is not a fully sealed relationship however, and any gases under pressure in the vessel are vented or ventable through this gasket as the pressure in the vessel increases. Then after initial compressing pressure is applied inside the chamber, and trapped or entrained gases such as air are vented out through the gasket's not yet perfect seal, the transfer medium is pressed against the silicone inside the gasket, and the silicone inside the gasket in turn slightly deforms the angled member into an increasingly effective interference fit with the respective mating surface.

Once this phase of increasing pressure has ‘set’ the gasket, the pressure is further increased to operational range, with each increment of pressure serving to further pressurize and hold the angled member against its sealing surface via the pressure transfer laterally through the silicone in the gasket to the angled member. Such gaskets desirably have a corner-free, or rounded, or U-shaped cross-section at the junction of the outer (or inner) member and the angled member. When the pressure in the chamber is reduced, and the corresponding pressure holding the angled member against its respective sealing or mating surface is released, the angled member springs back to its un-pressured configuration and dimension (permitted by the silicone's resilience), and the gasket ceases to be an interference fit, and the chamber lid or door is thus readily opened.

An alternative to the sealing process and mechanism disclosed above employs a kind of mating wedge and socket mechanism as an escape valve for trapped gasses; desirably, the wedge is in the form of a truncated or frusto-cone, and the socket is shaped and sized to suit the shape of the wedge.

One problem with the development of such an escape valve for high pressure presses is that to the extent such a valve represents an opening to the atmosphere or outside of the pump, the pressure medium (such as silicon) can be pressed through the valve, as well as the intended escaping air, especially at high operating pressures.

One way to avoid having pressure medium pressed out, is to stage the increases in pressure, such that there is first a pressure sufficient to press out trapped air, but not high enough pressure to cause pressure medium to enter the relatively narrow confines of the valve. Then when the air or other gas is gone, increasing the pressure against the wedge to seal it into its socket, before the pressure medium can be pressed out in any significant amount. Desirably, at least one surface of the wedge and or of the mating surface in the socket is either knurled lightly, or simply mechanically roughed slightly. These rough edges impose no significant barrier to the release of air through the valve, and as pressure is increased, the knurling or roughness is crushed into an effective sealing surface so pressure medium cannot escape.

One advantageous way to employ this wedge and socket valve mechanism is in conjunction with a modification of an otherwise conventional vacuum bag. The modified bag has a wedge-shaped valve piece incorporated into it, such that the wedge can be plugged into a socket surface in an outer wall or floor of the press, or alternatively built into the mold piece itself. Each composite part is bagged and plugged into an available socket, and then the staged pressure process begins, as disclosed above, first increasing pressure around the bag and the part to compress it preliminarily and to press or drive all trapped gas out of the bag, out past the wedge and into and through the socket; then secondly, to increase pressure in the press sufficiently to drive the wedge into the socket in full sealing engagement, so neither the bag, nor any part of the part, nor any of the pressure medium can be forced out the valve. This obviates the need for any kind of vacuum line inside the pump (which in any case would simply be crushed by the working pressure of the pump).

### Preform Deep Draw

New method and apparatus for deep drawing composite materials are disclosed that leave drawn sheets of ballistic material with no cuts, thus transforming flat sheet composite material into three-dimensional shapes such as helmets, face masks, or any other desired shape.

In conjunction with otherwise conventional match die press apparatus and processes for otherwise conventionally drawing composite sheet materials into a female mold shape, new matching rippled guide molds are used on the periphery of the female draw mold to guide the materials through as they are pushed through into the female draw mold shape by the action of the male part of the match die, or other kind of draw mold, press.

These “ripples” encourage the composite material to fold at the lines created by the ripples, and the action of the press pushes the thus folded material into the female mold. The female mold is designed to accept additional material at the locations of the ripples, which provides additional space for the folded material as compared to the straight material, while at the same time using the pressure of the press to stretch and limit the thickness of the folds to present a generally more uniform thickness.

The matching rippled guide molds are also male and female, and advantageously generally ring shaped, to fit around the circumference or periphery of the respective female and male draw mold parts. These peripheral rippled molds are generally conically disposed, to reduce friction on the material and avoid damage to the ballistic sheets as they are pressed through into the female draw mold.

By intentionally placing folds in the composite material as it is drawn and pressed, where the additional space in the female mold is needed to allow for the extra fold thicknesses can be accommodate. Part of the process includes providing active pressure on the composite material as it is drawn and folded, so that where the folds occur, they are pushed to the limit of the composite material, reducing the size of the folds. Since too much pressure on the folds can damage the composite material, balancing of draw forces maintains the ballistic characteristic of the material.

In addition to the strength of the material being maintained through use of whole sheets, the process also creates a “pleating effect” in the pressed composite material. This pleating effect is believed to generate additional time and space for capturing projectiles before they can break through the composite. Additionally, the pleating is believed to actively spread the load created by the impact over a wider area for minimal backface, and provides much lower subjective impact to the protected person or vehicle because the surface area of the impact is spread over a wider effective area.

### BRIEF DESCRIPTION OF THE DRAWINGS

FIG. 1 is a schematic illustration of an embodiment of a wedging gasket for the disclosed press.

FIG. 2 is a schematic illustration of an alternate embodiment of an active sealing system with wedging gasket for the disclosed press.

### BEST MODE OF CARRYING OUT THE INVENTION

Turning now to the drawings, a preferred embodiment is described by reference to the numerals of drawing figures, where applicable, wherein like numbers indicate like parts.

### Active Sealing

“Active sealing” means delayed commitment to a full seal until after the air is exhausted.

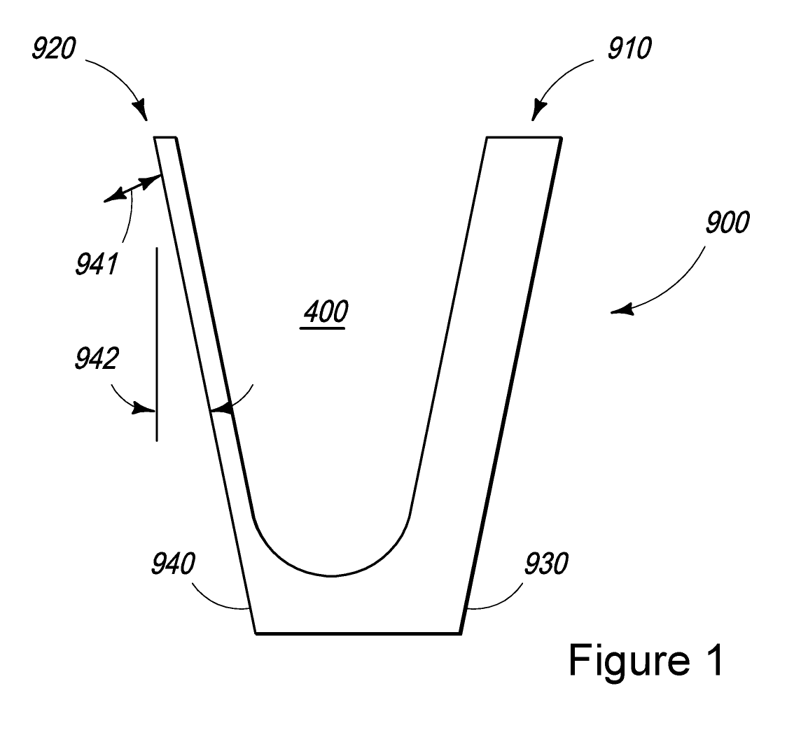

In FIG. 1, wedging gasket shown generally at 900 has outer relatively rigid member 910 with surface 930 that is in mating press fit relationship to the vessel or lid (not shown) to be sealed, and another slightly angled inner slightly resilient member 920 with mating surface 940. Member 920 is desirably at angle 942, where angle 942 is the smallest working angle needed to effect the fit and release of the gasket with the venting properties disclosed herein. Appropriate working values for angle 942 have been found to be in the range of 6 to 45 degrees and more particularly 8 to 12 degrees. The space or void between gasket member 910 and angled member 920 is filled with silicone 400 or other substantially incompressible but elastomeric medium. In operation, as the lid is closed or the pressure chamber is otherwise closed, angled inner member 920 is preliminarily mated with its respective sealing surface. Then after initial compressing pressure is applied inside the chamber and trapped or entrained gases such as air are vented out through the gasket's not yet perfect seal, the transfer medium (not shown) is pressed against silicone 400 and it in turn slightly deforms angled member 920 in the direction indicated by arrow 941 into an increasingly perfect interference fit with the respective mating surface (not shown). When the pressure in the chamber is reduced, and the corresponding pressure in silicone 400 holding angled member 920 against its respective sealing or mating surface is released, angled member 920 springs back to its un-pressured configuration and dimension in the other return direction indicated by arrow 941.

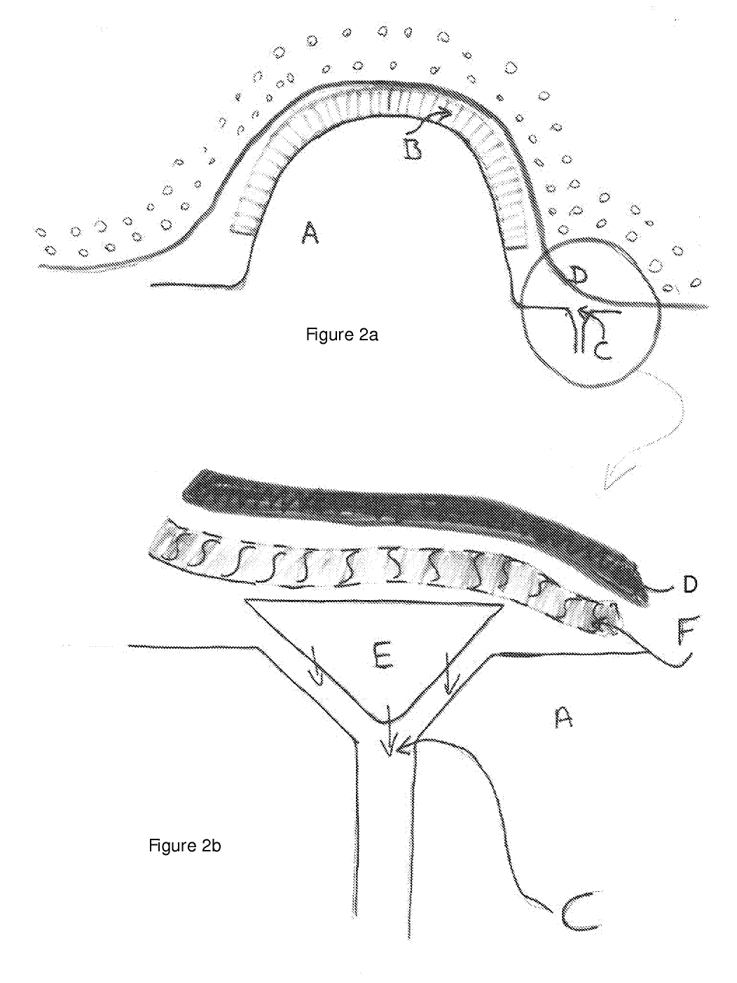

In FIG. 2, composite part B is wrapped around mold piece A and covered with vacuum bag D (note detail around gas port C, FIG. 2b). Mold A has gas port C, into which is fitted wedge E for gas or air evacuation or release during a first lower pressure stage. Breather cloth F is advantageously fitted either over or around wedge E to facilitate and or enhance passage of air through the tight space between wedge E and gas port C. This breather cloth F is compressible and, when wrapped around wedge E, is adapted to be crushed by the second stage higher pressure to form a full working seal, even to hold back the pressure medium itself.

In one example in a square press, a ring shaped active seal floats and has an approximately triangular cross section. In the cylindrical breach-type press, the example is a circular ring with an approximately trapezoidal cross section. In either example, the angles of the cross-sections of the sealing ring and the corresponding sealing surfaces into which they are pressed are essentially the same, but surfaces are left rough or even just dirty so sealing is not immediate is a first lower pressure stage.

### Preform Deep Draw

### Example:

Using 34 layers of DSM Dyneema HB 80 sheet material, preheat material to 250 degrees. Place a sheet of Spectra cloth under the HB 80. Place the preheated sheets on top of the female mold with its generally conical ring shaped female ripple cut guide. Place a second sheet of Spectra cloth on top of the HB 80. Engage a corresponding male ripple cut guide (desirably made from polyethylene) on top of the HB 80 and Spectra cloth.

Using a clamp, hold the two ripple cut guides tightly together. Clamping force is desirably adjusted to the point where the ensuing male mold press step just draws sheet material smoothly and without damage through the ripple guides without hesitation or snagging. Once the ripple cut guides are clamped, pass the male mold through the center of the ripple cut guides, smoothly and evenly drawing the material through the clamped guides and pressing the HB 80 material into the female mold. Hold under pressure until the HB 80 cools. This process creates a shell that can then optionally be further processed utilizing omnidirectional pressure from a Bariclave or other HIP press to finish the composite.

Other materials can be drawn in the same fashion, for example HB 26, HB 80, Honeywell 3130, Honeywell 3124, or combining polyethylene sheets such as Honeywell products and Dyneema HB 26, 50, and 80 with Kevlar products to draw composites with rigid interiors and semi rigid cores.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A wedging gasket comprising an outer relatively rigid member with a surface that is in mating press fit relationship to a vessel or lid to be sealed, and a slightly angled inner slightly resilient member appropriately shaped to mate with a respective other part of the vessel or lid to be sealed, generally in something less than an interference fit.
